(19) United States
(12) Patent Application Publication
(10) Pub. No.: US 2020/0173374 A1
(43) Pub. Date: Jun. 4, 2020

(54) METHOD AND SYSTEM FOR CONTROLLING A THROTTLE SIGNAL

(71) Applicant: HIPPO Power, LLC, Riverside, MO (US)

(72) Inventors: John Daniel Jones, Leawood, KS (US); Sean Christopher Willoughby, Lenexa, KS (US); Claire Elizabeth Ashley, Overland Park, KS (US); Michael Joseph Blank, Kansas City, MO (US); David Lee Messick, Liberty, MO (US)

(21) Appl. No.: 16/701,772

(22) Filed: Dec. 3, 2019

Related U.S. Application Data
(60) Provisional application No. 62/774,735, filed on Dec. 3, 2018.

(51) Int. Cl. F02D 9/02; B60K 31/00

(52) U.S. Cl. CPC F02D 9/02; B60K 31/00; B60R 16/0231; F02D 2200/602; F02D 2009/023

(57) ABSTRACT

A system for controlling a throttle signal, as well as methods of assembling the same, is provided. Controlling the throttle signal includes activating a supply of power to an electronic control unit (ECU). A first throttle signal associated with a throttle position signal of a vehicle throttle is communicated. An initial gear state of the vehicle is determined. Based on the initial gear state of the vehicle, a modified throttle signal to the ECU is communicated in response to receiving a command signal. Based on determining a change in the gear state of the vehicle, terminating the communication of the modified throttle signal. A second throttle signal that is associated with a second throttle position signal of the vehicle throttle is communicated.

### CROSS-REFERENCE TO RELATED APPLICATIONS AND CLAIM OF PRIORITY

This Non-Provisional patent application claims priority benefit of U.S. Provisional Patent Application No. 62/774,735, filed Dec. 3, 2018, titled “Method and System for Controlling a Throttle Signal,” having Attorney Docket No. 34948.319842, the entire contents of which is hereby incorporated into this specification by this reference.

### TECHNICAL FIELD

The present disclosure relates to systems and methods of controlling a throttle signal of a vehicle in order control an output of an alternator. Much of the discussion that follows will relate to controlling the throttle signal in order to utilize an in-engine mounted alternator to provide electrical power to auxiliary electrical components. However, it is to be appreciated that systems and methods of the present invention could have other uses.

### BACKGROUND OF INVENTION

Generally, the vehicle's engine RPMs are controlled by an electronic control unit (ECU). The ECU reads the position of the vehicle's throttle lever and delivers an air and gas mixture to the internal combustion engine accordingly. However, the ECU is typically not programmed to control the engine with respect to an additional alternator. Reprogramming of the ECU to account for an alternator output (e.g., increasing the idle state of the engine so as to increase the power output of the alternator) introduces multiple technical problems. For example, the ECU may be programmed with proprietary code to which only authorized technicians are given access. Additionally, reprogramming the ECU may trigger safety concerns and the original equipment manufacturer (OEM) may no longer certify the ECU if the software code is altered. Lastly, reprogramming the ECU may require specialized computer applications and equipment, which may not be readily accessible. As such, technical challenges exist for controlling the vehicle's engine RPMs utilizing an OEM ECU.

### SUMMARY

This summary is intended to introduce a selection of concepts in a simplified form that are further described below in the detailed description section of this disclosure. This summary is not intended to identify key or essential features of the claimed subject matter, and it is not intended to be used as an aid in isolation for determining the scope of the claimed subject matter.

In brief, and at a high level, this disclosure describes controlling a throttle signal of a drive-by-wire system without reprogramming the ECU. More specifically, the present disclosure describes methods, apparatuses, and systems for controlling the throttle signal communicated to the ECU. The throttle signal may be modified in response to receiving a command signal so as to achieve a particular RPM output of an internal combustion engine. The particular RPM output may be utilized by an alternator to generate electrical power for auxiliary electrical components of a vehicle.

In one embodiment hereof, a method for controlling a throttle signal for a vehicle is described. The method may comprise activating a power supply to an electronic control unit (ECU) for an internal combustion engine. Additionally, the method may comprise communicating, to the ECU, a first throttle signal associated with a throttle position signal of a vehicle throttle. The method may further comprise determining an initial gear state of the vehicle. Based on the initial gear state of the vehicle, the method can comprise communicating a modified throttle signal to the ECU that increases the RPM output of the internal combustion engine in response to receiving a command signal. Further, the method may comprise terminating the communication of the modified throttle signal based on determining a change in the gear state of the vehicle. The method may further comprise communicating, to the ECU, a second throttle signal with a second throttle position signal of the vehicle throttle.

In another embodiment hereof, the disclosure describes one or more computer storage media having computer-executable instructions embodied thereon that, when executed by a processor, perform the method of controlling a throttle signal for a vehicle. The method comprises activating a power supply to an ECU for an internal combustion engine. The method also comprises communicating, to the ECU, a first throttle signal associated with a throttle position signal of a vehicle throttle. Additionally, the method comprises determining an initial gear state of the vehicle. The method further comprises, based on the initial gear state of the vehicle, communicating a modified throttle signal to the ECU that increases the RPM output of the internal combustion engine in response to receiving a command signal. The method also comprises, based on determining a change in the gear state of the vehicle, terminating the communication of the modified throttle signal. The method additionally comprises communicating, to the ECU, a second throttle signal that is associated with a second throttle position signal of the vehicle throttle.

### BRIEF DESCRIPTION OF THE DRAWINGS

The subject matter disclosed herein is described in detail with reference to the attached drawing figures, which are intended to illustrate non-limiting examples of the disclosed subject matter related to supplemental alternators, in which like numerals refer to like elements, wherein:

FIG. 1 is an exemplary system diagram in accordance with some embodiments of the present disclosure;

FIG. 2 is an exemplary flow diagram showing a method for booting up a controller in accordance with some embodiments of the present disclosure; and

FIG. 3 is an exemplary flow diagram showing a method for controlling a throttle signal in accordance with some embodiments of the present disclosure.

### DETAILED DESCRIPTION

The subject matter of the invention is described herein to meet statutory requirements. However, this description is not intended to limit the scope of the invention. Rather, the claimed subject matter may be embodied in other ways, to include different steps, combinations of steps, features, and/or combinations of features, similar to those described in this disclosure, and in conjunction with other present or future technologies. Moreover, although the terms “step” and/or “block” may be used herein to identify different elements of methods employed, the terms should not be interpreted as implying any particular order among or between various steps or blocks except when the order is explicitly described and required.

At a high level, this disclosure relates to controlling a throttle signal of a drive-by-wire system. The throttle signal can be controlled so as to obtain a particular output in a vehicle's alternator. In particular, the throttle signal can be controlled to maximize the efficiency of a vehicle's engine while maximizing the electrical output of an alternator that is driven by a crankshaft of the vehicle's engine. In some aspects, the alternator is an additional alternator that is mounted alongside the vehicle's existing alternator. As such, in addition to the vehicle's crankshaft driving the existing alternator that powers the vehicle's electrical system (e.g., a 12 vDC system), the additional in-engine alternator can power electrical systems (e.g., a 24 vDC system) beyond that of the vehicle's electrical system. Accordingly, the secondary alternator can be used to deliver additional electrical needs such as radio battery charging, operation of tactical radios, transmission amplifiers, ground surveillance radar systems, thermal imagers, and electronic-counter-measure (ECM) systems, such as a system to actively jam command detonated IED detonation signals.

Generally, the vehicle's engine RPMs are controlled by an electronic control unit (ECU). The ECU reads the position of the vehicle's throttle lever and delivers an air and gas mixture to the internal combustion engine accordingly. However, the ECU is typically not programmed to control the engine with respect to an additional alternator. Reprogramming of the ECU to account for an alternator output (e.g., increasing the idle state of the engine so as to increase the power output of the alternator) introduces multiple problems.

For example, reprogramming the ECU can be expensive and time-consuming as it may require specifically-trained technicians. For example, some ECUs may provide a read/write interface allowing a technician to reprogram the ECU. However, reprogramming throttle control software through a read/write CANbus digital interface may be prohibitively expensive due to barriers for entry for reprogramming the ECU. For instance, only OEM certified technicians may be given access to reprogram the ECU. That is, an application designer or technician may not be given access to the operational parameters of the proprietary code of the ECU. Additionally, modification of the ECU may be discouraged or prohibited as any modifications may trigger safety concerns to the vehicle operator and the OEM manufacturer can no longer certify the software system. As such, it may be expensive to make any modifications to the ECU code because it may require that the reconfigured ECU under-go extensive testing for re-certification of the software.

Additionally, even if specifically-trained technicians are capable of reprograming the computer code of the ECU, it can still be cost-prohibitive. For example, reprogramming the ECU may require particular computer applications and equipment. Additionally, reprogramming the ECU may require hiring a trained technician, which can be expensive. Even more, in some instances, the vehicle may not be easily accessible to a trained technician as the vehicle is located in a remote location. As such, to reprogram the ECU, either the vehicle or the technician, or both, must be transported so that the technician can reprogram the ECU. Transporting the technician or the vehicle can further increase the cost and time of reprogramming the ECU.

Even more, in some cases, the ECU is designed by a vehicle manufacturer so as to restrict access to or the control of the ECU. As described above, some ECUs have a read/write CANbus digital interface. However, some ECUs may not have a read/write CANbus digital interface. That is, an ECU may only have a read port which limits a user from accessing or controlling the ECU.

Given the foregoing, in its broadest sense, the present disclosure relates to controlling a throttle signal that is communicated to the ECU. For example, methods, apparatuses, and systems are described herein that control the throttle signal between a throttle sensor associated with the vehicle throttle (e.g., an accelerator pedal) and an ECU. In some embodiments, a throttle position signal from the throttle sensor can be interrupted and a prescriptive signal (such as a simulated throttle signal) can be generated and communicated to the ECU. In some aspects, the prescriptive signal is a modified throttle signal that achieves a high-idle state. In some instances, the modified signal is a prescriptive signal that may or may not reflect the actual throttle position signal that is communicated by a throttle sensor. The modified throttle signal can be communicated to the ECU to achieve a particular or minimum RPM in the vehicle's internal combustion engine. In turn, the vehicle's internal combustion engine crankshaft can drive an alternator (e.g., a 24 vDC alternator that is mounted alongside a 12 vDC vehicle alternator) to produce a higher amount of electrical power. Among other things, this can achieve greater efficiency in the engine's internal combustion engine while maximizing the output of electric power from the alternator. In this way, the high-idle state can be initiated and maintained for any period of time.

Continuing with the exemplary embodiments, the high-idle state can be terminated based on a change in the state of a gear (e.g., the gear state may change after an operator shifts from Park to Drive). In other words, the high-idle state may end as a result in detecting a change to the gear state. For example, based on a change in the particular state of the gear, the modified throttle signal can be terminated such that a controller no longer instructs the ECU to maintain the high-idle state. Based on terminating the modified throttle signal, a throttle signal that is associated with the actual position of the throttle can be communicated to the ECU. Said differently, the throttle signal can reflect the throttle position signal produced or controlled by the throttle sensor. If the vehicle throttle is not depressed, the ECU may maintain a standard idle rate in the engine, sometimes referred to herein as a low-idle state.

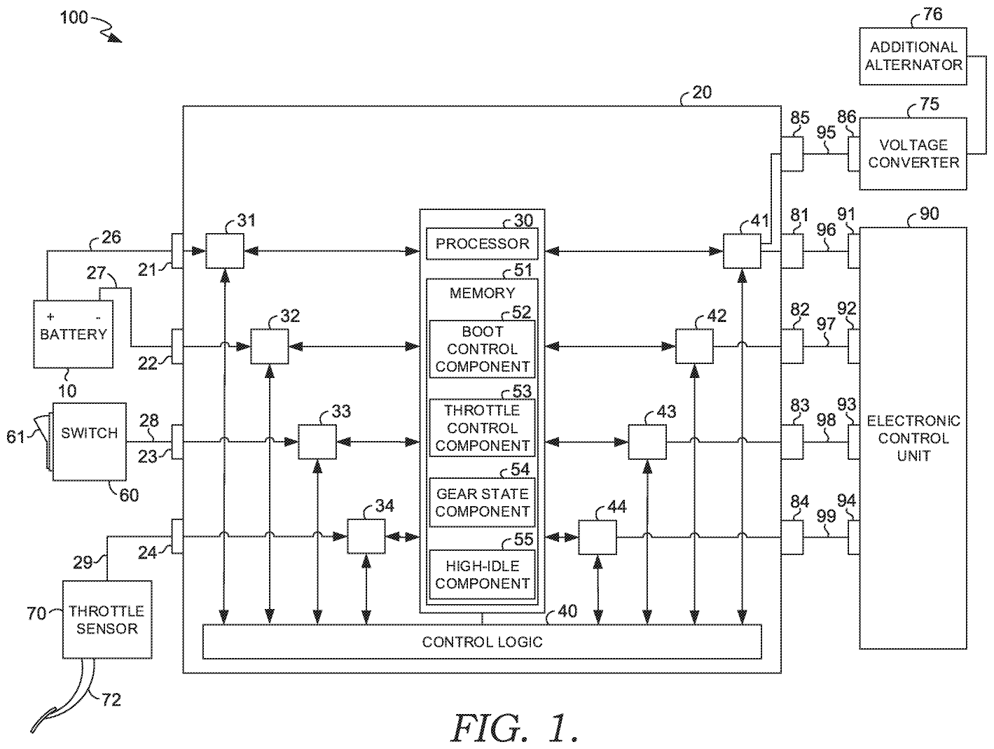

Referring initially to FIG. 1, an exemplary system 100 is depicted in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software.

In some embodiments, the system 100 comprises a controller 20. In some aspects, various functions of the controller 20 may be carried out by a processor 30 (e.g., a central processing unit) executing instructions stored in memory, such as memory 51. Memory 51 includes computer-storage media in the form of volatile and/or nonvolatile memory. The memory may be removable, non-removable, or a combination thereof. Exemplary hardware devices include solid-state memory, hard drives, optical-disc drives, etc. Memory 51 can be RAM, SRAM, flash, ROM, EPROM, or EEPROM.

In some embodiments, the controller 20 may have multifunctional input/output ports (e.g., one or more physical interfaces 21 22, 23, 24, 81, 82, 83, 84, and 85) that can receive input signals and send output signals. In some aspects, the input and output signals can be converted (e.g., analog to digital or digital to analog) or controlled by one or more signal converters/controllers 31, 32, 33, 34, 41, 42, 43, and 44. Input and output signals can also be controlled by control logic 40 or a processor executing computer-executable instructions. By way of example only, control logic 40 may include fixed logic, configurable logic, or electronically programmable logic arrays built from functional cells including nand gates, nor gates, and storage elements (such as data flip flops). As signal converters and controllers are known in the art, the one or more signal converters/controllers 31, 32, 33, 34, 41, 42, 43, and 44 and control logic 40 are not described in detail herein. In addition, as known in the art, the controller 20 is capable of generating one or more signals. For example, based on control logic 40 or a processor executing computer-executable instructions, the controller 20 may generate one or more signals.

As illustrated in FIG. 1, the system 100 includes, a throttle sensor 70, an electronic control unit (ECU) 90, a controller 20, a switch sensor 60, a power source (e.g., battery 10), a voltage converter 75, and an alternator 76. The controller 20 may be in communication with or coupled to the throttle sensor 70, the ECU 90, the switch sensor 60, the power source (e.g., battery 10), the voltage converter 75, and the alternator 76. In some embodiments, the controller 20 comprises one or more components, such as a boot control component 52, a throttle control component 53, a gear state component 54, or a high-idle component 55. As shown in FIG. 1, the one or more components can be software components stored in memory 51.

In some embodiments, the controller 20 can receive, as an input, a throttle position signal from the throttle sensor 70. The controller 20 can communicate the throttle position signal to the ECU 90 in the form of a throttle signal. The ECU 90 can control the rate of fuel delivered to an internal combustion engine based on the throttle signal. It should be appreciated that the engine may have a crankshaft that mechanically drives an alternator through a belt. In other words, based on the signals communicated to the ECU 90, the ECU 90 can facilitate a particular RPM of a vehicle's engine. For example, when an operator manipulates a throttle pedal lever 72 to an increased deflection, the throttle sensor 70 can send one or more throttle position signals (e.g., an analog signal). The one or more throttle position signals can then be communicated to the ECU 90 to increase or decrease the amount of fuel to the engine. Additionally, the ECU 90 may be programmed to have a predefined low-idle state. The low-idle state usually occurs when the vehicle is in park and when there is no deflection in the throttle pedal lever 72.

As shown in FIG. 1, in some embodiments, the controller 20 may intercept the throttle position signal (e.g., an analog 0 to 5 volt signal). In other words, the throttle position signal from the throttle sensor 70 can be received and redirected through the controller 20 before it is communicated to the ECU 90. For instance, the controller 20 may receive the throttle position signal at a throttle input physical interface 24 that is communicatively coupled to the throttle sensor 70 via a cable group 29. In turn, the controller 20 can relay the signal to the ECU 90. By communicating the signal to the ECU, the controller 20 can effect a particular RPM of the vehicle's engine. Because the crankshaft of the vehicle's engine can drive an alternator (such as an additional alternator that is mounted in combination with the existing alternator), an increase in RPMs can achieve a greater amount of electrical output from the alternator.

In some embodiments, the controller 20 may comprise a throttle control component 53. The throttle control component 53 can control the throttle signal communicated to the ECU 90. In some embodiments, the throttle control component 53 generates a prescriptive throttle signal. In some aspects, the prescriptive throttle signal simulates the throttle position signal that is received by the controller 20. It should be appreciated that while this disclosure describes the throttle control component 53 as generating the throttle signal, in reality, the throttle control component 53 causes the controller 20 to generate the signal. The controller 20 can then communicate the throttle signal to the ECU 90. For example, the controller 20 can communicate the throttle signal via a throttle output physical interface 84 that is communicatively coupled (e.g., through one or more throttle signal cable groups 99) to a throttle signal port 94 of the ECU 90.

As noted, the throttle signal communicated by the controller 20 to the ECU 90 can be a simulated throttle signal. The simulated throttle signal can mimic or reflect the throttle position signal that is received from the throttle sensor 70. For example, the throttle control component 53 can analyze the throttle position signal and generate a throttle signal that replicates the throttle position signal. In other words, the throttle control component 53 can generate a signal that replicates or mimics the throttle position signal. For example, as opposed to relaying the actual signal received from the throttle sensor 70 to the ECU 90, the throttle control component 53 can intercept the throttle position signal and generate a prescriptive signal that is then communicated to the ECU 90. It is within the scope of this disclosure that, in some embodiments, the throttle control component 53 can cause the controller 20 to relay the original throttle position signal received from the throttle sensor 70 onto the ECU 90.

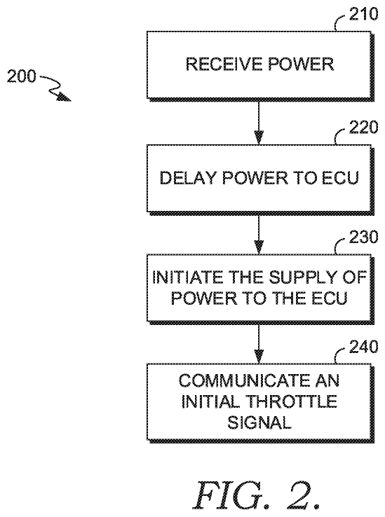

In some embodiments, the throttle signal that is communicated to the ECU 90 is an initial throttle signal. For example, upon the powering up (i.e., boot up) of the ECU 90, the controller 20 may communicate an initial throttle signal to the ECU 90. In some embodiments, the ECU 90 may be preprogrammed to read an initial reading of the throttle upon boot up. Communicating an initial throttle signal is advantageous because the ECU 90 can go into a lock-down mode (where it can stop operation of the engine) if it is unable to detect an initial throttle signal. As one skilled in the art would appreciate, exiting the lock-down mode may require restarting the ECU 90. As described in greater detail with respect to FIG. 2, to reduce the possibility of entering the lock-down mode, the controller 20 may delay the boot up of the ECU 90 for a time so as to ensure that the initial throttle signal is timely provided to the ECU 90. In other words, in some embodiments, the ECU 90 may have a shorter boot up time than the controller 20. As such, the controller 20 may delay providing power to ECU 90 so that it boots up after the controller 20.

In some embodiments, the controller 20 may comprise a gear state component 54. The gear state component 54 generally determines one or more gear states of the vehicle. For example, the controller 20 can receive a gear state signal from the ECU 90 via a gear state cable group 98 (e.g., a CANbus) that communicatively couples a gear state physical interface 83 of the controller 20 to a gear physical interface 93 of the ECU 90, as illustrated in FIG. 1. As described in greater detail below, the gear state may be relevant in determining whether to enter or exit a high-idle state.

Continuing, the gear state component 54 can analyze the received gear state signal and determine one or more gear states of the vehicle. In some aspects, the gear state component 54 can determine whether the vehicle is in a disengaged gear state, such as Park or Neutral. A disengaged gear state generally refers to instances when the vehicle is not propelled by the engine. Additionally, the gear state component 54 can determine whether the vehicle is in an engaged gear state, such as Drive, Low, or High. An engaged gear state generally refers to instances where the vehicle is propelled by the engine. The gear state component 54 can then communicate the gear state or one or more determinations about the gear state to other controller components, such as the boot control component 52, the throttle control component 53, and the high-idle component 55.

### High-Idle State

In various embodiments, the controller 20 comprises a high-idle component 55. The high-idle component 55 generally facilitates a high-idle state. The high-idle state generally refers to increasing the RPM of an engine so as to achieve a greater electrical output of an alternator. The high-idle component 55 can determine whether to initiate, maintain, or terminate the high-idle state. In some aspects, the high-idle component 55 can initiate, maintain, or terminate the high-idle state based on whether a switch 61 is in an engaged state. Additionally or alternatively, the high-idle component 55 can initiate, maintain, or terminate the high-idle state based on the gear state.

As described, the high-idle component 55 can determine the state of a switch 61. As illustrated in FIG. 1, the controller 20 can be in communication with a switch sensor 60 over a switch cable group 28 that communicatively couples the switch sensor 60 to the switch physical interface 23 of the controller 20. If the switch sensor 60 receives an indication from an operator (e.g., through a rocker switch or a digital display), the switch sensor 60 can communicate a signal to the controller 20. By way of example only, the signal may be an analog signal such that a particular voltage represents that the switch 61 has been activated or engaged (e.g., “on”). In some aspects, if switch 61 has been activated, the switch sensor 60 can communicate a command signal. The command signal generally refers to a signal that indicates that the switch 61 has been activated or engaged. In some embodiments, no signal may be communicated to the controller (e.g., a signal of 0 volts) when the switch 61 is inactivated or disengaged (e.g., “off”). In some aspects, based on determining that a switch 61 has been activated (e.g., the switch is on), the high-idle component 55 can instruct the controller 20 to enter or maintain a high-idle state. In some aspects, based on the determining that the switch 61 has been deactivated (i.e., no command signal is received), the high-idle component 55 can determine to terminate the high-idle state.

It should be noted that the switch 61 can be any type of switch. However, for safety reasons, a momentary switch may be preferable to a maintained switch (e.g., a rocker switch). A momentary switch can prevent the vehicle from accidentally returning to a high-idle state when the vehicle is shifted back into Park and the operator did not previously disengage the switch 61. With a momentary switch the controller 20 looks for the signal from the switch 61 to go high. When a high signal is received from the switch 61 by the controller 20, the controller latches the output and causes the vehicle to go to a high-idle state. The controller 20 will unlatch the output if it receives a second or subsequent signal from the momentary switch 61, or if the vehicle is shifted out of Park, or if power is lost (e.g., vehicle turned off). This ensures that the vehicle will remain at low idle when shifted back into Park even if the switch wasn't used to terminate the high-idle state. Similarly, a magnetic switch may be used. The magnetic switch would stay in an “on” position until the magnetic switch is manually moved to “off” by an operator or the high-idle component 55 moves out of the high-idle state because the vehicle is moved out of Park or is turned off. Any combination of switches may also be used to accomplish the goals stated herein.

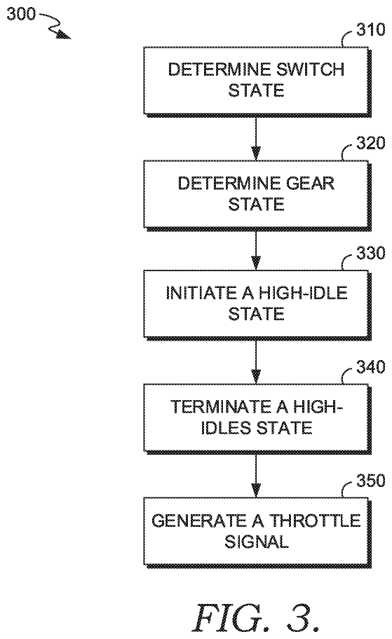

In addition to the high-idle component 55 being able to initiate, maintain, or terminate the high-idle state in response to a command signal (or lack thereof) from the switch sensor 60 via the switch 61, as described herein, the high-idle component 55 can also initiate, maintain, or terminate the high-idle state based on the gear state. In some embodiments, the high-idle component 55 can communicate with the gear state component 54 so as to determine the gear state of the vehicle. While described in greater detail in FIG. 3, the gear state component 54 can communicate an initial gear state to the high-idle component 55. The high-idle component 55 can then initiate the high-idle state based on determining that the initial gear state is a disengaged gear state (such as Park or Neutral). The high-idle component 55 can then continuously determine the gear state in order to maintain the high-idle state. In some embodiments, based on a change in the gear state (e.g., from a disengaged state to an engaged state), the high-idle component 55 can terminate the high-idle state.

In various embodiments, the high-idle component 55 can communicate with the throttle control component 53 to initiate, maintain, or terminate a high-idle state. For example, the high-idle component 55 can instruct the throttle control component 53 to generate a modified throttle signal during the high-idle state. The controller 20 can then communicate the modified throttle signal to the ECU 90. In some aspects, the modified throttle signal is a prescriptive throttle signal that does not necessarily mimic the actual throttle position signal. Rather, the modified throttle signal may be a prescriptive throttle signal that achieves a particular RPM in the engine. As such, the modified throttle signal can be associated with achieving a particular electrical output of an alternator. As is known in the art, an alternator's electrical output can be determined based on a particular crankshaft RPM.

Continuing, the modified throttle signal can be a throttle signal that achieves a higher RPM in the engine than what would otherwise be achieved by a throttle position signal. This can be advantageous in instances where the controller 20 is maximizing the efficiency of the vehicle's engine while maintaining an increased electrical output for an alternator. It should be appreciated that, in some embodiments, because the gear state may be in a disengaged state (e.g., Park), the modified throttle signal will not propel the vehicle forward. As such, communicating a modified throttle signal when the vehicle is in a disengaged gear state can increase the overall safety to the vehicle and the vehicle operators.

In exemplary aspects, the modified throttle signal may be preprogrammed into the controller 20. By way of example, the modified throttle signal may be pre-programmed into either the throttle control component 53 or the high-idle component 55. As such, if the high-idle component 55 determines that the high-idle state should be initiated, maintained, or terminated, this determination can be communicated with throttle control component 53. In turn, the throttle control component 53 may no longer generate the modified signal. For example, based on the termination of the high-idle state, the throttle control component 53 can generate a throttle signal that mimics the throttle position signal. Any and all aspects of terminating the controller's 20 generation or communication of the modified throttle signal is considered within the scope of this disclosure.

In various embodiments, the high-idle state can be terminated based on a change in the gear state. For example, if the gear state changes from a disengaged state (e.g., Park or Neutral) to an engaged state (e.g., Drive, Low, or High), the high-idle component 55 can determine a need to terminate the high-idle state. As described herein, the gear state component 54 can continuously determine the gear state of the vehicle. The high-idle component 55 can utilize the determinations by the gear state component 54 in order to detect a change in the gear state. In some embodiments, based on detecting a change in gear state, the high-idle component 55 can cause the controller to no longer generate or communicate the modified throttle signal to the ECU 90.

### Boot-Up Cycle

In various embodiments, the controller 20 comprises a boot control component 52. The boot control component 52 generally facilitates a proper boot up of the ECU 90 or excitation of the alternator 76. As such, the boot control component 52 can control the boot up of the ECU 90 to ensure that the ECU 90 does not go into lock-down mode based on the ECU's failure to detect an initial throttle signal. In various embodiments, the boot control component 52 can control the boot up of the ECU 90 by controlling the power provided to the ECU 90. For instance, the boot control component 52 can activate or initiate the supply of power to the ECU 90. The boot control component 52 can also control the excitation of the alternator 76 by controlling the power provided to the voltage converter 75.

In some embodiments, as illustrated in FIG. 1, the power supplied to the ECU 90 can be rerouted through the controller 20. Said differently, the controller 20 can intercept the power and selectively provide power to the ECU 90. As shown, the controller 20 may receive power from the battery 10 through one or more power input cable groups 26, 27 that are connected to one or more power input physical interfaces 21, 22 of the controller 20. In some aspects, the battery 10 is a 12 vDC battery. The controller 20 can then supply power to the ECU 90 through a one or more power output cable groups 96, 97. Power output cable groups 96, 97 can be coupled to controller 20 at one or more power output physical interfaces 81, 82. The power output cables groups 96, 97 may couple to one or more power input physical interfaces 91, 92 on the ECU. In this way, controller 20 can be installed to intercept the supply of power from the battery 10 and selectively provide power to the ECU 90. Because the power is rerouted through the controller 20, the boot control component 52 can determine when to supply power to the ECU 90. It is within the scope of the disclosure that the power may not be rerouted through the controller 20. As such, in some embodiments, the boot control component 52 can communicate with an external power controller and instruct it to provide or terminate the supply of power to the ECU 90.

Continuing, the boot control component 52 can facilitate a proper boot-up of the ECU 90 by delaying the power provided to the ECU 90. It should be appreciated that shortly after the ECU 90 receives the initial supply of power, the ECU 90 may require an initial throttle signal to prevent it from going into lock-down mode. Accordingly, in some embodiments, the boot control component 52 can delay the initial supply of power to the ECU 90 until the controller 20 is capable of communicating an initial throttle signal. The time for delaying the supply of power to the ECU 90 can be any amount of time to ensure that the controller 20 is able to communicate the initial throttle signal to the ECU 90 at the time needed by the ECU 90. By way of example only, the time delay may range from 1 millisecond to several seconds. In this way, the controller 20 can ensure that the initial throttle signal is communicated to the ECU 90 in a timely manner (e.g., upon the boot up of the ECU 90). Delaying the boot up of the ECU 90 can be advantageous in instances where the ECU 90 has a shorter boot up time than the controller 20. As such, delaying the power will prevent the ECU 90 from entering a lock-down mode if the controller 20 is not capable of timely providing an initial throttle signal.

Referring still to FIG. 1, the controller 20 may excite the alternator 76. As described, a vehicle may be modified to include a supplemental alternator that is mounted alongside a vehicle's existing alternator so as to provide power to additional electrical components. The alternator 76 may thus be a supplemental alternator, such as a 24 vDC alternator, that is mounted alongside a vehicle's existing 12 vDC alternator.

To excite the alternator 76, the controller 20 may utilize a vehicle's existing power source, such as battery 10. As described herein, the battery 10 may be a 12 vDC battery. Because the battery 10 is a 12 vDC battery, it is not capable of exciting a 24 vDC alternator. As such, in some aspects, the controller 20 may provide a signal from the vehicle's battery 10 to the voltage converter 75 to excite the alternator 76. For example, the controller 20 may provide a 12 vDC signal to the voltage converter 75 through physical interfaces 85, 86 and power cable 95. In turn, the voltage converter 75 may convert the 12 vDC signal to a 24 vDC signal, which is then communicated to the alternator 76. It should be appreciated that by utilizing the vehicle's existing power source in combination with the 12 vDC to 24 vDC converter, the additional alternator 76 may be excited without adding a supplemental power source (such as a 24 vDC battery). Additionally, while not illustrated, the voltage converter 75 may be protected from all open/short configurations for increased robustness and operation.

In some aspects, in addition to booting up the ECU 90, the boot control component 52 may also boot up the additional alternator 76. For instance, based on an ignition switch for a vehicle being turned to an “on” position, the boot control component 52 may communicate a signal to the voltage converter 75 to provide a 24 vDC signal to the alternator for excitation. The signal may be maintained until the vehicle ignition switch is turned to an “off” position. It is contemplated that the boot control component 52 communicates the signal prior to, simultaneously with, or after the ECU 90 boots up.

Turning now to FIG. 2, an exemplary flow diagram 200 shows a method for booting up a controller in accordance with some embodiments of the present disclosure. At step 210, a controller 20 receives power from a power source (e.g., battery 10). This may occur, for example, when an ignition system effectively closes the connection between the positive terminal of the battery 10 and the power input physical interface 21 by an ignition switch incorporated into cable group 26. When the ignition switch is turned to the “on” position, power is received at the controller 20.

At step 220, power supplied to the ECU 90 is delayed. In an embodiment, the boot control component 52 may control the power supplied to the ECU 90. For example, in some embodiments, the power is intercepted by the controller 20 and selectively supplied to the ECU 90. As such, the boot control component 52 can instruct the controller 20 to restrict or activate the flow of power to one or more power output physical interface 81, 82. For example, the boot control component 52 can control the power provided to the power output physical interface 81. The boot control component 52 can delay the power provided to the ECU 90 for any amount of time. In some embodiments, the boot control component 52 can delay the power based on a particular time frame (e.g., 1 millisecond to 1 second) that allows the controller 20 to boot up before the ECU 90. In some embodiments, the boot control component 52 can delay the power until the inputs and outputs of the controller 20 are stable, such as when the throttle control component 53 is outputting a throttle signal. Delaying the power provided to the ECU 90 can ensure that the ECU 90 does not go into lock-down mode based on the failure to timely receive an initial throttle signal.

At step 230, the boot control component 52 initiates the flow of power to the ECU 90. In some aspects, the boot control component 52 can instruct an external power source to provide power to the ECU 90. In some aspects, as illustrated in FIG. 1, the boot control component 52 can instruct the controller 20 to allow power to flow to the power output physical interfaces 81, 82, thereby providing power to the ECU 90 through one or more power output cable groups 96, 97.

At step 240, an initial throttle sensor reading is communicated to the ECU 90. In some aspects, the throttle control component 53 can generate the initial throttle signal that is communicated to the ECU 90 over one or more throttle signal cable groups 99. The initial throttle signal may be any throttle signal that the ECU 90 is required to receive in order to boot up correctly. In some embodiments, the initial throttle signal mimics or simulates the throttle position signal.

While not shown, the method may further include initiating the excitation of an alternator. In some aspects, the boot control component 52 initiates the excitation of 24 vDC alternator using a 12 vDC battery. When the ignition switch is turned to the “on” position, the boot control component 52 may communicate a 12 vDC signal to a voltage converter, which is then converted to 24 vDC and communicated to a 24 vDC alternator. In some aspects, the boot control component 52 initiates the excitation of the 24 vDC alternator after the ECU 90 is booted up.

Turning now to FIG. 3, an exemplary flow diagram 300 shows a method for controlling a throttle signal in accordance with some embodiments of the present disclosure. While not shown in flow diagram 300, the throttle control component 53 may provide a first throttle signal. In some embodiments, the first throttle signal is an initial throttle signal that can be communicated during the boot up of the ECU 90. It some embodiments, the first throttle signal is a simulated signal that is generated by the controller 20.

At step 310, the switch state is determined. The switch state may be determined by the high-idle component 55. By way of example, the high-idle component 55 may determine whether the switch sensor 60 is communicating a command signal indicating that the switch 61 is in an engaged state (e.g., the switch has been turned on by the operator).

At step 320, the gear state is determined. In some embodiments, the gear state component 54 can determine the gear state communicated by the ECU 90. The gear state component 54 can then communicate the state of the gear (or any changes thereto) to the high-idle component 55.

At step 330, the high-idle component 55 can determine to initiate (or maintain) the high-idle state. For example, the high-idle component 55 can determine to enter the high-idle state based on an initial gear state of the vehicle and in response to receiving a command signal from the switch sensor 60. Accordingly, at step 330, the high-idle component 55 can communicate with the throttle control component 53 and instruct the throttle control component 53 to generate a modified throttle signal. As described herein, the modified throttle signal can cause an increase in the RPM output of the internal combustion engine when communicated to the ECU 90. In some embodiments, the high-idle component 55 can maintain the high-idle state for any period of time. In should be appreciated that to maintain the high-idle state, the high-idle component 55 can continuously repeat steps 310 or 320.

It should be appreciated that, in various embodiments, the high-idle component 55 determines not to initiate the high-idle state. For instance, the high-idle component 55 may determine that the switch state is off. Additionally or alternatively, the high-idle component 55 may determine that the gear state is in an engaged state, such as Drive. Based on one or more of these determinations, the high-idle component 55 can determine not to enter the high-idle state.

At step 340, a high-idle state can be terminated. In some embodiments, the high-idle component 55 can terminate the high-idle state. For example, the high-idle component 55 can terminate the high-idle state based on a determination that the switch state is off (e.g., the switch sensor 60 is no longer communicating a command signal). Additionally or alternatively, the high-idle component 55 can terminate the high-idle state based on a determination that the gear is now in an engaged state (e.g., Drive) as opposed to a disengaged state (e.g., Park). In other words, based on detecting a change in the gear state, the high-idle component 55 can terminate the high-idle state. By way of a non-limiting example, the high-idle state can be terminated based on the high-idle component 55 instructing the throttle control component 53 to terminate the generation of the modified throttle signal. Additionally or alternatively, the high-idle component 55 can instruct the throttle control component 53 to generate a throttle signal that mimics the throttle position signal. For example, the throttle control component 53 can generate one or more throttle signals that are associated with a throttle position signal of the vehicle throttle as manipulated by a human operator.

At step 350, the throttle signal can be communicated from the controller 20 to the ECU 90. In some embodiments, the throttle signal may be a simulated signal that is generated based on the throttle position sensor signal that is received from the throttle sensor 70, which may be manipulated by a depression of the throttle pedal lever 72.

The present technology has been described in relation to particular embodiments, which are intended in all respects to be illustrative rather than restrictive. Alternative embodiments will become apparent to those of ordinary skill in the art to which the present technology pertains without departing from its scope. Different combinations of elements, as well as use of elements not shown, are possible and contemplated. It will be understood that certain features and sub-combinations are of utility and may be employed without reference to other features and sub-combinations. This is contemplated by and is within the scope of the claims. From the foregoing it will be seen that this invention is one well adapted to attain all ends and objects hereinabove set forth together with the other advantages which are obvious and which are inherent to the method and apparatus. It will be understood that certain features and subcombinations are of utility and may be employed without reference to other features and subcombinations. This is contemplated by and is within the scope of the invention.

What is claimed is:

1. A method for controlling a throttle signal for a vehicle comprising:
activating a supply of power to an electronic control unit (ECU) for an internal combustion engine;
communicating, to the ECU, a first throttle signal associated with a throttle position signal of a vehicle throttle;
determining an initial gear state of the vehicle;
based on the initial gear state of the vehicle, communicating a modified throttle signal to the ECU that increases an RPM output of the internal combustion engine in response to receiving a command signal;
based on determining a change in the gear state of the vehicle, terminating the communication of the modified throttle signal; and
communicating, to the ECU, a second throttle signal that is associated with a second throttle position signal of the vehicle throttle.

2. The method of claim 1, wherein the modified throttle signal is associated with a predetermined throttle signal that is based on an electrical output of an alternator.

3. The method of claim 1, wherein each of the first throttle signal and the second throttle signal is a simulated throttle signal that is determined based on the throttle position signal.

4. The method of claim 1, wherein the initial gear state of the vehicle is a disengaged gear state, and wherein the change in gear state is from the disengaged gear state to an engaged gear state.

5. The method of claim 1, wherein the method further comprises initiating an excitation of a 24 vDC alternator utilizing a vehicle's battery.

6. The method of claim 1, wherein the method further comprises delaying the supply of power to the ECU.

7. The method of claim 6, wherein the first throttle signal is an initial throttle signal that is communicated prior to boot up of the ECU.

8. A controller for controlling a throttle signal for a vehicle comprising:
a processor;
one or more computer storage media having computer-executable instructions embodied thereon that, when executed by the processor, perform the method comprising:
activating a supply of power to an electronic control unit (ECU) for an internal combustion engine;
communicating, to the ECU, a first throttle signal associated with a throttle position signal of a vehicle throttle;
determining an initial gear state of the vehicle;
based on the initial gear state of the vehicle, communicating a modified throttle signal to the ECU that increases an RPM output of the internal combustion engine in response to receiving a command signal;
based on determining a change in the gear state of the vehicle, terminating the communication of the modified throttle signal; and
communicating, to the ECU, a second throttle signal that is associated with a second throttle position signal of the vehicle throttle.

9. The controller of claim 8, wherein the modified throttle signal is associated with a predetermined throttle signal that is based on an electrical output of an alternator.

10. The controller of claim 8, wherein the initial gear state of the vehicle is in a disengaged gear state, and wherein the change in gear state is from the disengaged gear state to an engaged gear state.

11. The controller of claim 8, wherein the method further comprises initiating an excitation of a 24 vDC alternator utilizing a vehicle's battery.

12. The controller of claim 8, wherein each of the first throttle signal and the second throttle signal is a simulated throttle signal that is determined based on the throttle position signal.

13. The controller of claim 8, wherein the method further comprises delaying the supply of power to the ECU.

14. The controller of claim 13, wherein the first throttle signal is an initial throttle signal that is communicated to the ECU prior to boot up of the ECU.

15. One or more computer storage media having computer-executable instructions embodied thereon that, when executed by a processor, perform the method of controlling a throttle signal for a vehicle, the method comprising:
activating a supply of power to an electronic control unit (ECU) for an internal combustion engine;
communicating, to the ECU, a first throttle signal associated with a throttle position signal of a vehicle throttle;
determining an initial gear state of the vehicle;
based on the initial gear state of the vehicle, communicating a modified throttle signal to the ECU that increases an RPM output of the internal combustion engine in response to receiving a command signal;
based on determining a change in the gear state of the vehicle, terminating the communication of the modified throttle signal; and
communicating, to the ECU, a second throttle signal that is associated with a second throttle position signal of the vehicle throttle.

16. The media of claim 15, wherein the modified throttle signal is associated with a predetermined throttle signal that is based on an electrical output of an alternator.

17. The media of claim 15, wherein the initial gear state of the vehicle is in a disengaged gear state, and wherein the change in gear state is from the disengaged gear state to an engaged gear state.

18. The media of claim 15, wherein the method further comprises initiating an excitation of a 24 vDC alternator utilizing a vehicle's battery.

19. The media of claim 15, wherein each of the first throttle signal and the second throttle signal is a simulated throttle signal that is determined based on the throttle position signal.

20. The media of claim 15, wherein the method further comprises delaying the supply of power to the ECU, and wherein the first throttle signal is an initial throttle signal that is communicated prior to boot up of the ECU.
